(19) United States
(12) Patent Application Publication
(10) Pub. No.: US 2015/0006215 A1
(43) Pub. Date: Jan. 1, 2015

(54) TIME DIVISION CALENDAR SEGMENTATION

(71) Applicant: Avaya Inc., Basking Ridge, NJ (US)

(72) Inventors: Gene Uba, Broomfield, CO (US); Robert C. Steiner, Broomfield, CO (US); Jose Velez, Thornton, CO (US)

(21) Appl. No.: 13/930,155

(22) Filed: Jun. 28, 2013

(51) Int. Cl. G06Q 10/10; G06F 17/30

(52) U.S. Cl. CPC G06Q 10/1093; G06F 17/30324
USPC 705/7.18

(57) ABSTRACT

A contact center is provided with the ability to efficiently and effectively execute strategy rules by referencing and comparing schedules of contact center entities. The contact center includes a scheduling module configured to convert a textual calendar description of an entity into a bitmap representation of the calendar for that entity. A bitmap comparison can then be performed by a work assignment engine in accordance with the strategy rules being executed by the work assignment engine.

### FIELD OF THE DISCLOSURE

The present disclosure is generally directed toward communications and more specifically toward contact centers.

### BACKGROUND

Many entities (e.g., work, resources, services, sites, etc.) in a contact center are tied to some sort of calendar or schedule. For example, hours of operation, emergency hours, and holiday schedules are all forms of typical calendars that are consulted frequently in a contact center, especially by a work assignment engine. Operations such as looking up a resource's availability are expensive because the work assignment engine has to look at lists of calendars or call external systems to see if the current time is within the rules of each of those calendars.

### SUMMARY

Embodiments of the present disclosure significantly increase the efficiency of calendar and scheduling operations by taking calendar descriptions and producing calendars that are represented in memory by bitmaps, where each bit represents a time segment.

In particular, embodiments of the present disclosure provide a mechanism for converting a calendar of an entity (e.g., work, resources, services, sites, etc.) from a textual calendar description stored in a database or a set of rules in an application (e.g., Microsoft Outlook®) into an in-memory representation of the calendar that is optimized for efficient look-ups and comparisons. In some embodiments, this in-memory representation may correspond to a calendar that is broken into a series of time segments of equal length, where each time segment is represented in memory as a single bit. For example, if an hour is broken into four (4) time segments of 15 minutes each, then a calendar window of one week could be represented as a continuous series of 224 (4*8*7) time segments. In memory, this series of time segments can be effectively implemented as a bitmap where each bit in the bitmap represents one time segment.

An example of a textual representation of a calendar is provided below:

Calendar MyCalendar valid[2012-01-01..2016-01-01]
{

Open Monday..Friday [07:00:00..12:00:00, 13:00:00..17:00:00] Except
{
2012/06/02..2012/06/04 [08:00:00..12:00:00] “Reduced Hours”,
2012-09-04 [10:00:00..12:00:00] “Labor Day”,
2012-11-21 [08:00:00..12:00:00] “Thanksgiving”,
2012-11-23 [05:00:00..07:00:00] “Thanksgiving (Modified Hours)”,
2012-11-24 [05:00:00..12:00:00, 13:00:00..23:00:00] “Thanksgiving (Extended

Hours)”,

2012-12-31 [07:00:00..11:00:00] “New Year's Eve”,
2012-04-06 [07:00:00..10:00:00]
},
Open Saturday [10:00:00..14:00:00],
Open Saturday [05:00:00..18:00:00],
Closed
{
Sunday,
2012/06/02..2012/06/04,
<Last Monday in May> “Memorial Day”,
<Fourth Day in July> “Independence Day”,
<First Monday in September> “Labor Day”,
<Fourth Thursday in November> “Thanksgiving”,
*-12-25 “Christmas”,
<First Day in January> “New Year”,
June..July “Building Construction”,
<Last Day in February [17:30:00]>..<First Day in March [17:30:00]> “Passover”
}

}

Another aspect of the present disclosure is that each textual representation within a calendar clause described above (e.g., Open, Open with Exception, and Closed) can be “computed” (e.g., converted from a textual representation into a bit value) at an administrable interval (e.g., every night at midnight, every weekend, etc.) for an administrable length of time into the future (e.g., the calendar can be computed for the following hour, day, week, etc.). The computation or conversion of the textual calendar results in a bitmap stored in memory as an array of bits where each bit represents the ‘OR’ing of all the calendar clauses of an entity for a particular time segment. When a strategy rule executes and it analyzes the calendar of an entity to determine if the calendar is currently open or closed, the bit for the current time segment (e.g., in the bitmap) is returned as the answer to the query. Multiple computed calendars could be potentially OR'ed to yield an open or closed result for a combination of entities. It should also be appreciated that AND operations may be useful in executing other strategy rules.

Another aspect of the present disclosure is to enable the scheduling module to predict when one or more entities will be available or unavailable by looking at the entity's bitmap one or more bits ahead of current time. This enables the scheduling module to predict when resources are leaving, for example, by looking one bit ahead in a calendar for a quick and easy lookup.

In short, embodiments of the present disclosure also enable a scheduling a module to convert the textual representation of an entity's calendar into a bitmap, thereby making the process of calendar look up and scheduling routines much more quick and efficient. Specifically, the time division calendar segmentation approach described herein provides tremendous savings on memory storage size and lookup performance.

In accordance with at least some embodiments of the present disclosure, a method is provided which generally comprises:

receiving calendar description information for a first entity;

analyzing the calendar description information to determine availability and non-availability information for the first entity during a plurality of time segments over a calendar window;

converting the calendar description information into binary calendar information based on the analysis of the calendar description information; and

storing the binary calendar description information in a non-transitory computer-readable memory.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting relationships between contact center entities and a scheduling module in accordance with embodiments of the present disclosure;

FIG. 3 is a block diagram depicting converted calendar information in accordance with embodiments of the present disclosure;

FIG. 4 is a flow diagram depicting a calendar conversion process in accordance with embodiments of the present disclosure;

FIG. 5 is a flow diagram depicting a scheduling process in accordance with embodiments of the present disclosure; and

FIG. 6 is a block diagram depicting a plurality of data structures utilized in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

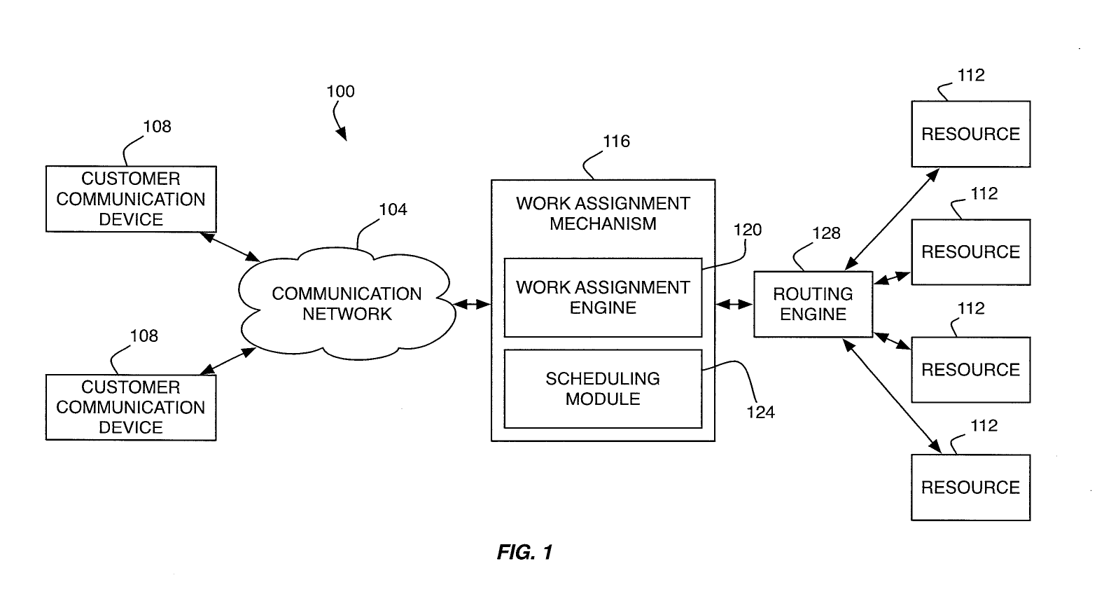

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 128 to connect the communication device 108 which initiated the communication with the assigned resource 112.

Although the routing engine 128 is depicted as being separate from the work assignment mechanism 116, the routing engine 128 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 128. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

More specifically, the work assignment engine 120 can determine which of the plurality of processing resources 112 is qualified and/or eligible to receive the work item and further determine which of the plurality of processing resources 112 is best suited to handle the processing needs of the work item. In situations of work item surplus, the work assignment engine 120 can also make the opposite determination (i.e., determine optimal assignment of a work item resource to a resource). In some embodiments, the work assignment engine 120 is configured to achieve true one-to-one matching by utilizing bitmaps/tables and other data structures.

In some embodiments, the work assignment engine 120 operates in concert with a scheduling module 124. The work assignment engine 120, as a part of making work assignment decisions, may need to determine whether a resource 112 is available, whether a work item is available, whether a contact center site is available, etc. In other words, each decision made by the work assignment engine 120 may require the work assignment engine 120 to analyze calendar information for multiple entities in the contact center. The scheduling module 124 provides a mechanism for building calendars and, in some embodiments, may also perform calendar or schedule analysis on behalf of the work assignment engine 120 (e.g., as a called function). In particular, the scheduling module 124 may be configured to compute binary calendar information for every entity in a contact center and perform simple calendar comparison to determine if a work item is or will be available at the same time as a resource 112, a contact center site, or some other service. Thus, the rules executed by the work assignment engine 120 (e.g., match a work item to a best resource 112) may be assisted by the functionality of the scheduling module 124.

The work assignment engine 120 and/or the scheduling module 124 and their various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

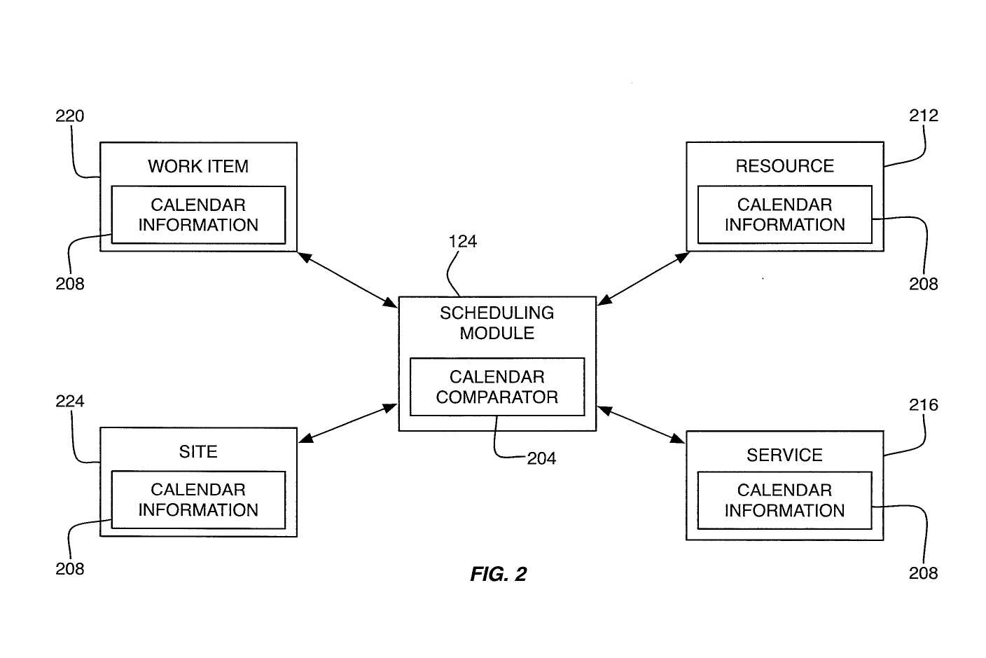

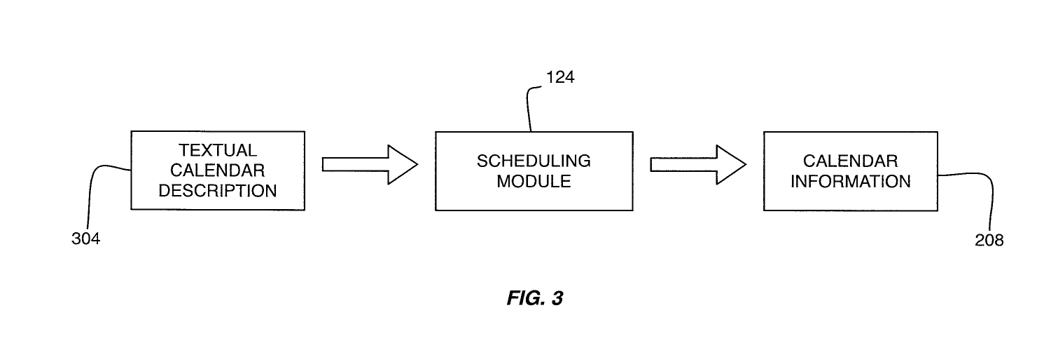

With reference now to FIGS. 2 and 3, additional functionality of the scheduling module 124 will be described in accordance with embodiments of the present disclosure. The scheduling module 124 may be configured to execute a number of functions in connection with providing calendaring and/or scheduling functions for use by the work assignment engine. Examples of such functions include, without limitation, the ability to compare calendar information 208 of a plurality of different entities in a contact center and the ability to generate calendar information 208 based on textual calendar description information, thereby making the analysis and/or comparison of calendar information 208 more efficient.

More specifically, the scheduling module 124 may be provided with a calendar comparator 204 that enables the scheduling module 124 to receive calendar information 208 from one or more of a resource 212 (e.g., similar or identical to resource 112), a service 216, a work item 220, and/or a contact center site 224. The calendar information 208 analyzed and compared by the calendar comparator 204 may be in the form of one or more bitmaps, where each bit in a bitmap represents a time segment and the bit value assigned for a time segment represents whether the entity is available or unavailable.

As shown in FIG. 3, the calendar information 208 may be obtained by converting textual calendar description information 304 into binary calendar description information 208. The conversion process performed by the scheduling module 124 may be done either continuously (e.g., every processing time period) or non-continuously on a periodic basis. When performed periodically, the amount of time between conversion or calculations may be on the order of minutes, hours, days, weeks, months, etc. Furthermore, the textual calendar description information 304 may be converted into binary calendar information for a calendar window (e.g., predetermined amount of time into the future, which may or may not include past time segments). More specifically, the textual calendar description information 304 may comprise an entity's schedule for any amount of time in the future (e.g., months, years, etc.), whereas the binary calendar information 208 may only correspond to a portion of that entity's schedule. The amount of time for which the binary calendar description information 208 is computed may be referred to as a calendar window. As can be appreciated, it may be desirable to compute a calendar window for an amount of time longer than the re-computing period. For example, if a calendar window is computed with a length of one day, then it may be desirable to re-compute the calendars of each entity in the contact center for an amount of time less than one day (e.g., every hour, every 12 hours, etc.). This ensures that up-to-date binary calendar description information 208 is computed on a useable basis.

In some embodiments, the conversion of a textual calendar description information 304 into a binary calendar description information 208 may include analyzing a window of time within the textual calendar description information 304 for an entity, determining an availability or unavailability of the entity for each segment of time, and then building a bit-value representation of the availability and unavailability of the entity for each segment of time, where the segments are represented by bits in a bitmap.

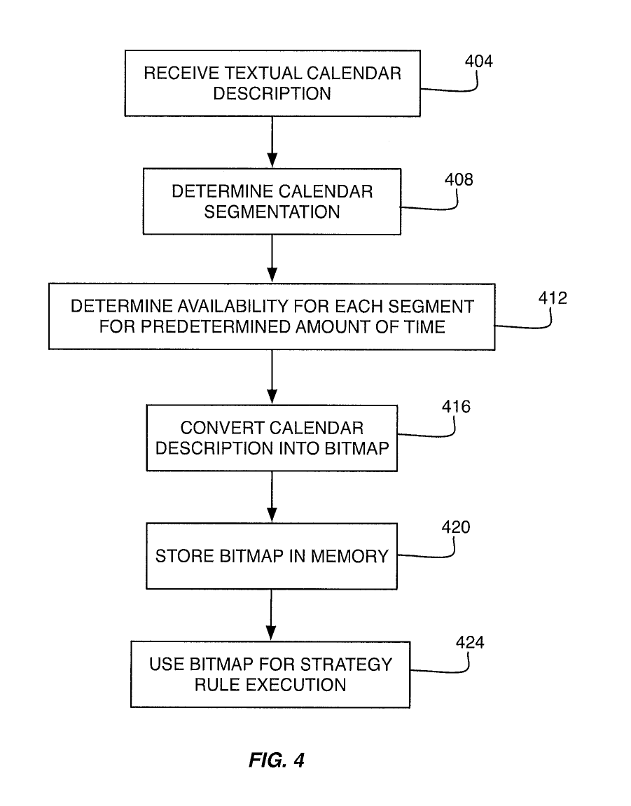

With reference now to FIG. 4, additional details of a process for converting a textual calendar description information 304 into binary calendar description information 208 will be described in accordance with embodiments of the present disclosure. The method begins when the scheduling module 124 receives the textual calendar description information 304 for an entity (e.g., a resource 212, service 216, work item 220, and/or site 224) (step 404). Although the examples described herein refer to a textual representation of calendar information, it should be appreciated that embodiments are not so limited. In particular, a non-bitmap representation of an entity's calendar may be received for conversion. The non-bitmap representation may actually be in binary form (e.g., computer-readable form), but the eventual representation of that data may be formatted for text and/or graphical presentation to a user. Thus, it should be appreciated that “textual” as used herein may correspond to any non-bitmap representation of a calendar. The actual state of the calendar data may be textual, ASCII text, other text, compiled data, un-compiled data, or the like. The use of “textual” representation of calendar information is to distinguish from a bitmap representation of calendar information and should not be construed as limiting the present invention.

The scheduling module 124 then determines the desired calendar segmentation for the calendar information (step 408). The desired calendar segmentation may be defined by dividing a predetermined calendar window by a predetermined integer value. Alternatively, the number of segments and the amount of time represented by each segment may be predetermined and the calendar window may be a result of those predetermined values. As a non-limiting example, the scheduling module 124 may determine that twenty (20) segments are desired with each segment to represent fifteen (15) minutes. Thus, the resultant calendar window may correspond to approximately five (5) hours of time, where the full calendar window may be forward looking (e.g., in the future where time>t) or one or more of the segments may correspond to a current time segment (e.g., time=t) or a past time segment (e.g., time<t).

Once the desired calendar segmentation has been determined, the method continues with the scheduling module 124 determining the availability and/or unavailability of the entity for each segment in the calendar window (step 412). Specifically, the scheduling module 124 may convert each entry for an entity into either an available or unavailable status. As an example, the scheduling module 124 may equate any scheduled meeting or appointment for an entity into a status of unavailable, whereas reminders and other similar types of calendar items may be equated to a status of available. The scheduling module 124 may also convert weekends, holidays, breaks, and the like into a status of unavailable, unless such events can be interrupted. As noted above, this analysis is performed for each segment of time in the entity's textual calendar description information 304.

Once the analysis is complete, the scheduling module 124 converts the textual calendar description information 304 into a bitmap (e.g., binary calendar description information 208) (step 416). The bitmap comprises a number of bits equal to the number of segments determined in step 408. The segments may be continuous with each subsequent bit value in the bitmap corresponding to a next time segment. The bitmap is then stored in memory (step 420) where it can be used by the work assignment engine 120 in connection with making work assignment decisions and other decisions which require the analysis of calendar information for contact center entities (step 424). In some embodiments, the bitmap may be stored in memory of a server that also hosts the work assignment mechanism 116. In other embodiments, some or all of the bitmap for an entity may be stored in an external database; however, the use of an in-memory representation of the bitmap may be preferred to facilitate quick calendar analysis operations by the work assignment engine 120.

As can be appreciated, the process of FIG. 4 may be repeated for every entity in the contact center every time the re-computation of calendar information 208 for the entities is desired.

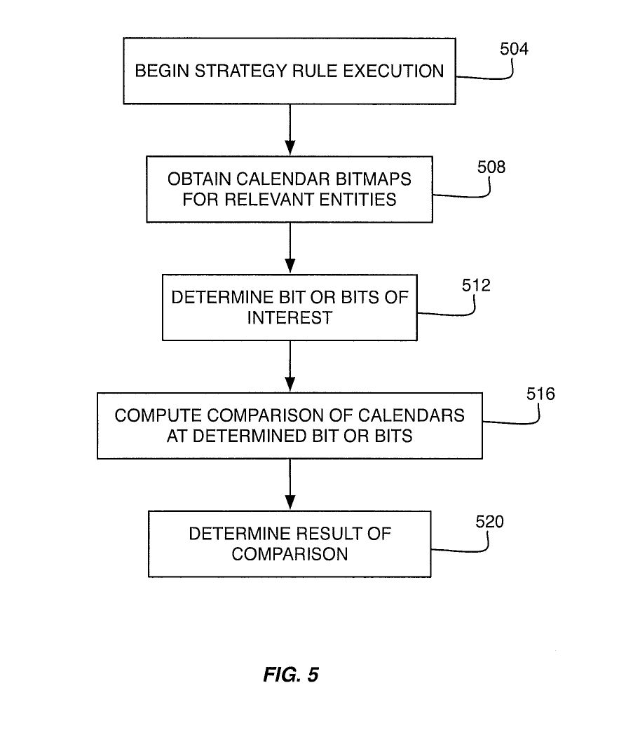

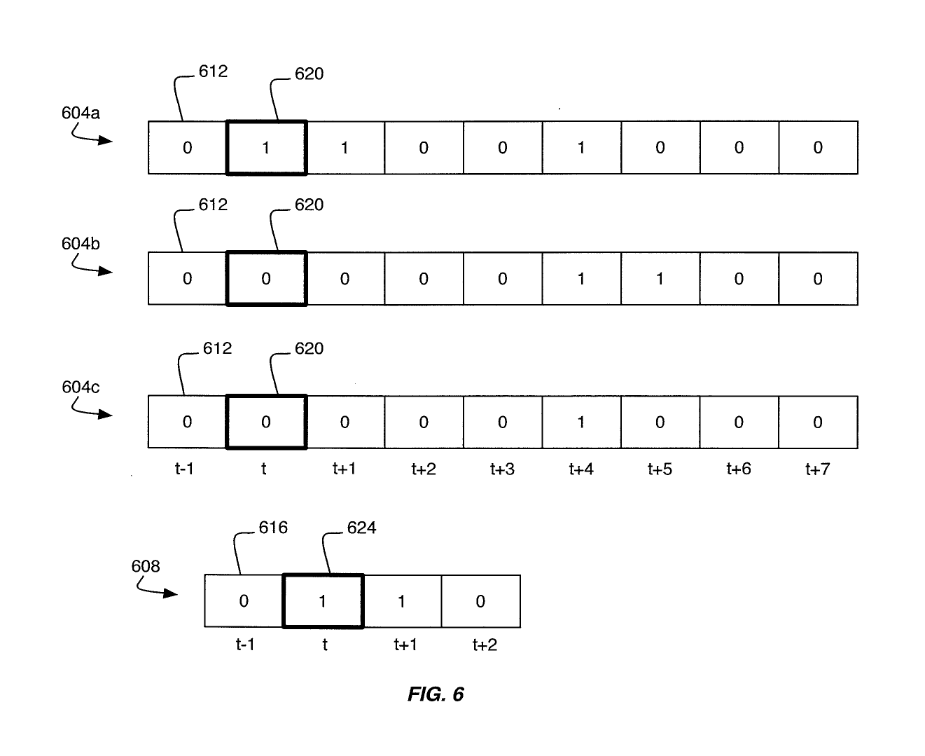

With reference now to FIGS. 5 and 6, additional details of a method for utilizing the calendar bitmaps (e.g., binary calendar description information 208) in connection with the execution of a strategy rule in a contact center will be described in accordance with embodiments of the present disclosure. The method begins with the work assignment engine 120 determining that a strategy rule requires execution (step 504). One example of a strategy rule that may be executed by the work assignment engine 120 is a work assignment decision. Specifically, the work assignment engine 120 may determine that a work item needs to be matched to a resource 112, a service, and/or contact center site.

Once the work assignment engine 120 starts the execution of the rule, the necessary calendar bitmaps 604a, 604b, 604c are obtained for the entities relevant to the strategy rule execution (step 508). Although FIG. 6 only depicts three bitmaps 604a, 604b, 604c corresponding to three entities, it should be appreciated that a greater or lesser number of bitmaps may be obtained in step 508. The bitmaps 604a, 604b, 604c may correspond to binary calendar description information 208 for one or more of a work item, resource, service, and/or contact center site. The calendar bitmaps may be obtained by the scheduling module 124 in response to being called by the work assignment engine 120 or the work assignment engine 120 may obtain the relevant bitmaps via the scheduling module 124.

As can be seen in FIG. 6, each bitmap 604a, 604, 604c may comprise a plurality of bit values where a first bit value 612 of each bitmap corresponds to a first time segment (e.g., time=t−1), where a second bit value 620 immediately succeeding the first bit value 612 corresponds to a second time segment (e.g., time=t or current time), etc. Although the bitmaps 604a, 604b, 604c are depicted as having eight bits corresponding to eight time segments, a greater or lesser number of bit values may be included in the bitmaps. Additionally, the number of bits in each bitmap does not necessarily have to be the same. Further still, the illustrative bitmaps 604a, 604b, 604c may use a first bit value to represent a first availability state (e.g., bit value of 1 equals unavailable) and a second bit value to represent a second availability state (e.g., bit value of 0 equal available).

The method continues with the scheduling module 124 and/or work assignment engine 120 determining bit or bits of interest to be analyzed in connection with the execution of the strategy rule (step 512). In the example of FIG. 6, the bit of interest corresponds to the second bit 620 in each bitmap 604a, 604b, 604c. Of course, the bit of interest may be in the future or past without departing from the scope of the present disclosure.

Thereafter, the bits of each bitmap 604a, 604b, 604c are analyzed/compared by (step 516) and the results of the comparison are used to complete the execution of the strategy rule (step 520). As an example, the work assignment engine 120 may use the results of the comparison to determine if a resource, service, and/or contact center site are available during a time segment requested for a work item. As another example, the work assignment engine 120 may use the results of the comparison to determine if any resources in a contact center site are available during a predetermined time in the future (e.g., when the bit of interest is at time t+N, where N is greater than or equal to 1).

In some embodiments, the analysis/comparison of bitmaps 604a, 604b, 604c may result in the creation of a bitmask 608 where each bit value in the bitmask 608 is a result of simultaneously analyzing bit values in each of the bitmaps 604a, 604b, 604c. Specifically, a first bit value 616 in the bitmask 608 may correspond to an AND'd value of each of the first bit values in the bitmaps 604a, 604b, 604c. Furthermore, a second bit value 624 in the bitmask 608 may correspond to an AND'd value of each of the second bit values in the bitmaps 604a, 604b, 604c. Thus, unless every entity is available during the same time segment (e.g., the segment of interest), the bit value in the bitmask with not indicate a combined availability. Although FIG. 6 only depicts a bitmask that is created as the result of an AND process, it should be appreciated that other Boolean operations (e.g., OR, XOR, NOR, NAND, etc.) can be performed on the bitmaps in connection with executing any number or type of strategy rules.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
receiving calendar description information for a first entity;
analyzing the calendar description information for the first entity to determine availability and non-availability information for the first entity during a plurality of time segments over a calendar window;
converting the calendar description information for the first entity into binary calendar information for the first entity based on the analysis of the calendar description information for the first entity; and
storing the binary calendar description information for the first entity in a non-transitory computer-readable memory.

2. The method of claim 1, wherein the binary calendar information for the first entity comprises a bitmap having a plurality of bit values and wherein each bit value in the plurality of bit values corresponds to a different time segment in the plurality of time segments.

3. The method of claim 2, wherein a bit value for a time segment is determined based on whether or not the first entity is available during a corresponding time segment.

4. The method of claim 1, wherein an amount of time covered by each time segment in the plurality of time segments equals a predetermined amount of time.

5. The method of claim 1, further comprising:
receiving calendar description information for a second entity;
analyzing the calendar description information for the second entity to determine availability and non-availability information for the second entity during a plurality of time segments over the calendar window;
converting the calendar description information for the second entity into binary calendar information for the second entity based on the analysis of the calendar description information for the second entity; and
storing the binary calendar description information for the second entity in the non-transitory computer-readable memory.

6. The method of claim 5, further comprising:
creating a bitmask by combining the binary calendar description information for the first entity with the binary calendar description information for the second entity; and
using the bitmask in connection with making a work item routing decision in a contact center.

7. The method of claim 8, wherein the bitmask is created by performing a Boolean operation on the binary calendar description information for the first entity and the binary calendar description information for the second entity.

8. The method of claim 1, wherein the first entity comprises at least one of a contact center work item, a contact center resource, a contact center service, and a contact center site.

9. The method of claim 1, wherein the binary calendar description information for the first entity is stored as a bitmap having a plurality of bits stored continuously in the non-transitory computer-readable memory.

10. A non-transitory computer readable medium having stored thereon instructions that cause a computing system to execute a method, the instructions comprising:
instructions configured to receive calendar description information for a first entity;
instructions configured to analyze the calendar description information for the first entity to determine availability and non-availability information for the first entity during a plurality of time segments over a calendar window;
instructions configured to convert the calendar description information for the first entity into binary calendar information for the first entity based on the analysis of the calendar description information for the first entity; and
instructions configured to store the binary calendar description information for the first entity in memory.

11. The computer readable medium of claim 10, wherein the binary calendar information for the first entity comprises a bitmap having a plurality of bit values and wherein each bit value in the plurality of bit values corresponds to a different time segment in the plurality of time segments.

12. The computer readable medium of claim 11, wherein a bit value for a time segment is determined based on whether or not the first entity is available during a corresponding time segment.

13. The computer readable medium of claim 10, wherein an amount of time covered by each time segment in the plurality of time segments equals a predetermined amount of time.

14. The computer readable medium of claim 10, the instructions further comprising:
instructions configured to receiving calendar description information for a second entity;
instructions configured to analyze the calendar description information for the second entity to determine availability and non-availability information for the second entity during a plurality of time segments over the calendar window;
instructions configured to convert the calendar description information for the second entity into binary calendar information for the second entity based on the analysis of the calendar description information for the second entity; and
instructions configured to store the binary calendar description information for the second entity in the memory.

15. The computer readable medium of claim 14, the instructions further comprising:
instructions configured to create a bitmask by combining the binary calendar description information for the first entity with the binary calendar description information for the second entity; and
instructions configured to use the bitmask in connection with making a work item routing decision in a contact center.

16. The computer readable medium of claim 15, wherein the bitmask is created by performing a Boolean operation on the binary calendar description information for the first entity and the binary calendar description information for the second entity.

17. A contact center, comprising:
a work assignment engine configured to execute one or more strategy rules that, as a part of execution, include an analysis of a first entity's schedule; and
a scheduling module configured to build a bitmap representation of the first entity's schedule thereby enabling bit comparisons as part of executing the one or more strategy rules.

18. The contact center of claim 17, wherein the bitmap comprises a plurality of bit values and wherein each bit value in the plurality of bit values corresponds to a different time segment in the first entity's schedule.

19. The contact center of claim 18, wherein a bit value for a time segment is determined based on whether or not the first entity is available during a corresponding time segment.

20. The contact center of claim 17, wherein the first entity comprises at least one of a contact center work item, a contact center resource, a contact center service, and a contact center site.
